(19) United States
(12) Patent Application Publication
(10) Pub. No.: US 2021/0211329 A1
(43) Pub. Date: Jul. 8, 2021

(54) METHODS OF NEXT GENERATION NODEB (GNODEB) SUPERVISED USER EQUIPMENT (UE) SOUNDING REFERENCE SIGNAL (SRS) TRANSMIT (TX) BEAM SWEEPING FOR 5G NEW RADIO (NR) UPLINK BEAM MANAGEMENT

(71) Applicant: Apple Inc., Cupertino, CA (US)

(72) Inventors: Zhibin Wu, Unterhaching (DE); Yushu Zhang, Beijing (CN); Alexei Davydov, Nizhny Novgorod (RU); Seunghee Han, San Jose, CA (US); Yeong-Sun Hwang, Oberhaching (DE)

(21) Appl. No.: 17/269,370

(22) PCT Filed: Sep. 16, 2019
(86) PCT No.: PCT/US2019/051256

§ 371 Date: Feb. 18, 2021

Related U.S. Application Data
(60) Provisional application No. 62/738,155, filed on Sep. 28, 2018.

(51) Int. Cl. H04L 25/02; H04L 5/00; H04W 76/27; H04W 8/24; H04W 72/04

(52) U.S. Cl. CPC H04L 25/0226; H04L 5/0051; H04W 72/042; H04W 8/24; H04W 76/27

(57) ABSTRACT

An apparatus configured to be employed in a gNodeB associated with a new radio (NR) communication system is disclosed. The apparatus comprises one or more processors configured to configure partial spatial reference information associated with at least one sounding reference signal (SRS) resource set of one or more SRS resource sets associated with a user equipment (UE), that forms a select SRS resource set. In some embodiments, the partial spatial reference information comprises information on a partial spatial reference resource configured for one or more SRS resources associated with the select SRS resource set, to be utilized by the UE to generate one or more SRS transmit beam patterns for transmitting the one or more SRS resources, respectively, such that the one or more SRS transmit beam patterns are in a spatial neighborhood of a beam pattern associated with the configured partial spatial reference resource.

### CROSS-REFERENCE TO RELATED APPLICATIONS

This application claims the benefit of and priority to U.S. Provisional Application No. 62/738,155, filed Sep. 28, 2018, entitled “NEXT GENERATION NODEB (GNB) SUPERVISED USER EQUIPMENT (UE) SOUNDING REFERENCE SIGNAL (SRS) TRANSMIT (TX) BEAM SWEEPING FOR FIFTH GENERATION (5G) NEW RADIO (NR) UPLINK BEAM MANAGEMENT”, the contents of which are herein incorporated by reference in their entirety.

### FIELD

The present disclosure relates to new radio (NR) systems, and in particular, to a system and a method to enable next generation nodeb (gNodeB) supervised user equipment (UE) sounding reference signal (SRS) transmit (Tx) beam sweeping for 5 g NR uplink beam management.

### BACKGROUND

5G New Radio (NR) technology supports very high data rate with lower latency compared to its predecessor LTE (4G) technology. 5G NR supports mmwave frequency band (from 24.25 GHz to 52.6 GHz). As the mmwave band uses very high frequency, it leads to propagation loss and other losses. To compensate for the losses, directional communication is essential at such frequencies. Antenna arrays with large number of antenna elements make directional communication possible due to smaller wavelengths. Directional communication provides beamforming gain to the radio frequency (RF) link budget which helps in compensation of propagation loss. Moreover, large antenna array helps to achieve higher data rate due to spatial multiplexing technique. These directional links require accurate alignment of transmitted and received beams. In order to achieve alignment of beam pair and to have required end to end performance with desired delay, beam management operations are introduced in the 5G NR. Beam management procedure is used in 5G NR in order to acquire and maintain a set of transmit/receive beams which can be used for downlink (DL) and uplink (UL) transmission/reception.

### BRIEF DESCRIPTION OF THE DRAWINGS

Some examples of circuits, apparatuses and/or methods will be described in the following by way of example only. In this context, reference will be made to the accompanying Figures.

FIG. 1 illustrates a simplified block diagram of new radio (NR) system, according to one embodiment of the disclosure.

FIG. 2 illustrates exemplary SRS beam patterns determined by a UE to be utilized to transmit one or more SRS resources associated with the UE, based on a partial reference resource, according to one embodiment of the disclosure.

FIG. 3 illustrates a use case of hierarchical sounding reference signal (SRS) transmit (Tx) beam sweeping, according to one embodiment of the disclosure.

FIG. 4 illustrates a block diagram of an apparatus employable at a Base Station (BS), eNodeB, gNodeB or other network device that facilitates to perform gNodeB supervised sounding reference signal (SRS) transmit (Tx) beam sweeping at the user equipment (UE) side, according to various aspects described herein.

FIG. 5 illustrates a block diagram of an apparatus employable at a user equipment (UE) or other network device (e.g., IoT device) that facilitates to perform gNodeB supervised sounding reference signal (SRS) transmit (Tx) beam sweeping at the user equipment (UE) side, according to various aspects described herein.

### DETAILED DESCRIPTION

In one embodiment of the disclosure, an apparatus configured to be employed in a gNodeB associated with a new radio (NR) communication system is disclosed. The apparatus comprises one or more processors configured to configure partial spatial reference information associated with at least one sounding reference signal (SRS) resource set of one or more SRS resource sets associated with a user equipment (UE), that forms a select SRS resource set comprising a set of SRS resources. In some embodiments, the partial spatial reference information associated with the select SRS resource set comprises information on a partial spatial reference resource configured for one or more SRS resources of the set of SRS resources associated with the select SRS resource set. In some embodiments, the partial spatial reference resource is to be utilized by the UE to generate one or more SRS transmit beam patterns for transmitting the one or more SRS resources, respectively associated with the select SRS resource set, such that the one or more SRS transmit beam patterns are in a spatial neighborhood of a beam pattern associated with the configured partial spatial reference resource. In some embodiments, the one or more processors is further configured to generate a partial spatial reference configuration signal comprising the configured partial spatial reference information associated with the at least one SRS resource set comprising the select SRS resource set. In some embodiments, the apparatus further comprises a radio frequency (RF) interface, configured to provide, to a radio frequency (RF) circuitry, the partial spatial reference configuration signal, for subsequent transmission to the UE.

In one embodiment of the disclosure, an apparatus configured to be employed in a user equipment (UE) associated with a new radio (NR) system is disclosed. The apparatus comprises one or more processors configured to process a partial spatial reference configuration signal, received from a gNodeB associated therewith. In some embodiments, the partial spatial reference configuration signal comprises partial spatial reference information configured for at least one sounding reference signal (SRS) resource set of one or more SRS resource sets associated with the UE, that forms a select SRS resource set comprising a set of SRS resources. In some embodiments, the partial spatial reference information configured for the select SRS resource set comprises information on a partial spatial reference resource configured for one or more SRS resources of the set of SRS resources associated with the select SRS resource set. In some embodiments, the one or more processors is further configured to determine the partial spatial reference resource configured for the one or more SRS resources associated with the select SRS resource set, based on processing the partial spatial reference configuration signal; and generate one or more SRS transmit beam patterns to be utilized by the UE for transmitting the one or more SRS resources, respectively associated with the select SRS resource set, to the gNodeB, based on the partial spatial reference resource. In some embodiments, the one or more SRS transmit beam patterns are in a spatial neighborhood of a beam pattern associated with the determined partial spatial reference resource.

In one embodiment of the disclosure, a computer readable storage device storing executable instructions that, in response to execution, cause one or more processors of a gNodeB to perform operations is disclosed. In some embodiments, the operation comprises configuring partial spatial reference information associated with at least one sounding reference signal (SRS) resource set of one or more SRS resource sets associated with a user equipment (UE), that forms a select SRS resource set comprising a set of SRS resources. In some embodiments, the partial spatial reference information associated with the select SRS resource set comprises information on a partial spatial reference resource configured for one or more SRS resources of the set of SRS resources associated with the select SRS resource set. In some embodiments, the partial spatial reference resource is to be utilized by the UE to generate one or more SRS transmit beam patterns for transmitting the one or more SRS resources, respectively associated with the select SRS resource set, such that the one or more SRS transmit beam patterns are in a spatial neighborhood of a beam pattern associated with the configured partial spatial reference resource. In some embodiments, the operations further comprise generating a partial spatial reference configuration signal comprising the configured partial spatial reference information associated with the at least one SRS resource set comprising the select SRS resource set; and providing the partial spatial reference configuration signal, to a radio frequency (RF) circuitry, for subsequent transmission to the UE.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” “circuit” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the event that the terms “including”, “includes”, “having”, “has”, “with”, or variants thereof are used in either the detailed description and the claims, such terms are intended to be inclusive in a manner similar to the term “comprising.”

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

As indicated above, beam management procedure is used in 5G NR in order to acquire and maintain a set of transmit/receive beams which can be used for downlink (DL) and uplink (UL) transmission/reception. Uplink beam management (UL BM) framework has been defined in Release 15 3GPP NR. In this framework, when UE does not support beam correspondence, gNodeB can allocate to the UE at least one beam management (BM) SRS resource set. In the embodiments described throughout the disclosure, the BM SRS resource set is referred to as SRS resource set. In some embodiments, each SRS resource set can contain at least one SRS resource. In some embodiments, the SRS resource may be further referred to as a beam management (BM) SRS resource. Accordingly, after being triggered by the gNodeB, UE is configured to sweep TX beam patterns when transmitting different SRS resources within a same SRS resource set, so that the gNodeB can acquire the best UL beam pairs between the UE TX beams and gNodeB RX beams. In some embodiments, the maximal number of SRS resources per SRS resource set can be up to 16. In order to enable gNodeB supervised UE SRS TX Beam Sweeping, in current implementations, gNodeB is configured to configure spatial reference resources for SRS resources (through SRS-spatialRelationInfo by RRC configuration) associated with a UE. When the spatial reference resource is configured, each SRS resource within an SRS resource set is associated to one spatial reference resource. The UE needs to generate the exactly the same TX beam pattern for transmitting the configured SRS as receiving/transmitting the indicated spatial reference resource. However, for UEs that does not support beam correspondence, generating the exact same beam pattern of the indicated spatial reference resource for transmitting the configured SRS resource is not possible. Further, configuring each SRS resource within an SRS resource set with one spatial reference resource limits the number of possible Tx beam patterns in the UE side. This further limit the supervised UE SRS TX beam sweeping based on spatial reference resources.

Furthermore, when the spatial reference resource is not configured, the Tx beam sweeping in the UE side by using the configured SRS is blind and restricted. For example, when the spatial reference resource is not configured for the UE, UE is operating in the slave mode in TX beam sweeping procedures. In other words, the UE receives no information of the swept beam quality and the UE has no information how the swept TX beams are used for RX beam acquisition in gNodeB side (e.g. the acquisitions for PUSCH and PUCCH can require in different sweeping optimizations). As a result, it is difficult for UE to apply hierarchical TX beam sweeping for better efficiency, but rather to sweep the TX beams blindly. Further, for UEs that do not support multiple SRS resource sets, the number of SRS resources is limited, which further limits the number of possible swept TX beam patterns in UE side. Further, if UE significantly changes a TX beam pattern for a same SRS ID, it may confuse the RX beam acquisition in the base station side because the base station may still assume the same TX beam pattern for the same SRS ID. This limits the UE TX beam sweeping capability so that UE can either do local TX beam sweeping with smaller number of narrow beams, or doing global TX beam sweeping with smaller number of wide beams. But UE has no information how to switching between the two sweeping modes.

Therefore, in order to overcome the above disadvantages, a system and a method to enable gNodeB supervised SRS Tx beam sweeping in the UE side is proposed in this disclosure. In particular, in one embodiment, a gNodeB configured to configure partial spatial reference information for at least one SRS resource set of one or more SRS resource sets associated with a UE, that forms a select SRS resource set is proposed herein. In some embodiments, the partial spatial reference information associated with the select SRS resource set comprises a partial spatial reference resource configured for one or more SRS resources of a set of SRS resources associated with the select SRS resource set. In some embodiments, the partial spatial reference resource is to be utilized by the UE to generate one or more SRS transmit beam patterns for transmitting the one or more SRS resources, respectively associated with the select SRS resource set. In some embodiments, the one or more SRS transmit beam patterns are in a spatial neighborhood of a beam pattern associated with the partial spatial reference resource configured for the one or more SRS resources associated with the select SRS resource set. In some embodiments, using SRS transmit (Tx) beam patterns that are in the spatial neighborhood of the configured partial spatial reference resource (and not using the exact beam pattern of the partial spatial reference resource) for transmitting SRS resources enables even the UEs that does not support beam correspondence to perform gNodeB supervised SRS transmit beam sweeping. Further, in another embodiment, a UE configured to generate a UE capability signal that indicates a number of SRS resources from different SRS resource sets that concurrently transmitted by the UE. Using multiple SRS resource sets increases the number of SRS resources which further increases the SRS TX beam candidates. In some embodiments, providing the UE capability signal further enables the gNodeB to avoid triggering a number of concurrent SRS resources which exceed the UE indicated capability.

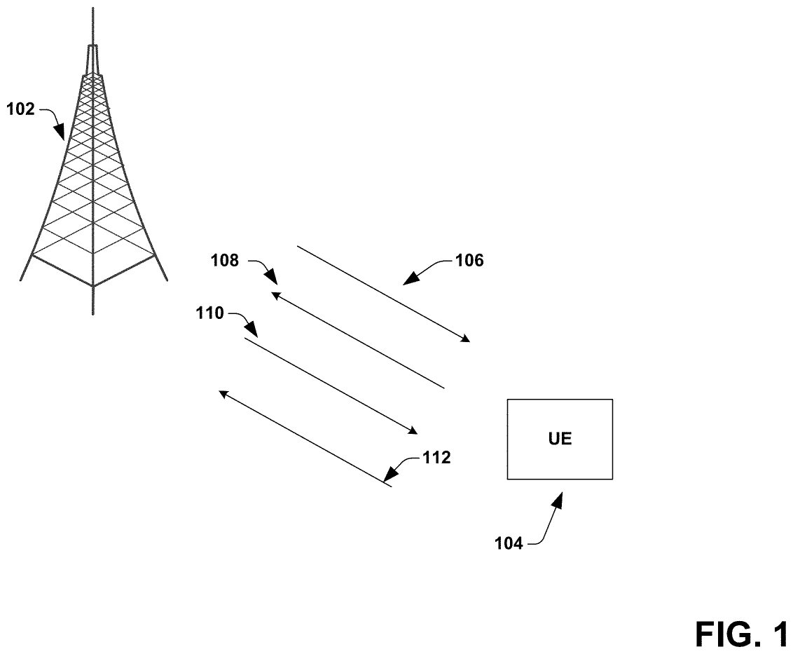

FIG. 1 illustrates a simplified block diagram of new radio (NR) system 100, according to one embodiment of the disclosure. In some embodiments, the NR system 100 facilitates to perform next generation nodeb (gNodeB) supervised sounding reference signal (SRS) transmit (Tx) beam sweeping at the user equipment (UE) side. The NR system 100 comprises an gNodeB 102 and a user equipment (UE) 104. In other embodiments, however, the NR system 100 can comprise a plurality of gNodeBs and UEs. In some embodiments, the gNodeB 102 is equivalent to a base station, an eNodeB in long term evolution (LTE) systems etc. In some embodiments, the UE 104 may comprise a mobile phone, tablet computer, an internet of things (IoT) device etc. The gNodeB 102 and the UE 104 are configured to communicate with one another over a communication medium (e.g., air). In some embodiments, the gNodeB 102 is configured to configure partial spatial reference information for one or more sounding reference signal (SRS) resource sets associated with the UE 104, in order to enable the UE 104 to perform gNodeB (e.g., the gNodeB 102) supervised SRS transmit (Tx) beam sweeping. In this embodiment, the gNodeB 102 is shown to configure the partial spatial reference information associated with just a single UE 104. However, in other embodiments, the gNodeB 102 may be configured to configure the partial spatial reference information associated with one or more UEs.

In some embodiments, the UE 104 is configured with one or more SRS resource sets, each SRS resource set comprising one or more SRS resources configured for the UE 104. In some embodiments, the gNodeB 102 is configured to configure partial spatial reference information for at least one SRS resource set of the one or more SRS resource sets associated with the UE 104, that forms a select SRS resource set. In some embodiments, the select SRS resource set comprises a set of SRS resources. However, in other embodiments, the gNodeB 102 may be configured to configure partial spatial reference information for more than one SRS resource set of the one or more SRS resource sets associated with the UE 104.

In some embodiments, the partial spatial reference information associated with the select SRS resource set comprises information on a partial spatial reference resource configured for one or more SRS resources of the set of SRS resources associated with the select SRS resource set. In some embodiments, the partial spatial reference resource is configured per SRS resource. In such embodiments, the partial spatial reference resource may be configured for a select SRS resource of the set of SRS resources associated with the select SRS resource set. In such embodiments, the partial spatial reference resource may comprise a plurality of partial spatial reference resources configured respectively for a plurality of SRS resources of the set of SRS resources associated with the select SRS resource set. Alternately, in other embodiments, the partial spatial reference resource is configured per SRS resource set. In such embodiments, the partial spatial reference resource may be configured for all the SRS resources of the set of SRS resources associated with the select SRS resource set.

In some embodiments, the partial spatial reference resource configured for one or more SRS resources of the set of SRS resources associated with the select SRS resource set of the UE 104, is to be provided to the UE 104, in order to enable the UE 104 to generate one or more SRS transmit beam patterns for transmitting the one or more SRS resources, respectively associated with the select SRS resource set. In some embodiments, the gNodeB 102 is further configured to generate a partial spatial reference configuration signal 106 comprising the configured partial spatial reference information associated with the at least one SRS resource set comprising the select SRS resource set and provide the generated partial spatial reference configuration signal 106 to the UE 104. However, in other embodiments, the partial spatial reference configuration signal 106 may comprise partial spatial reference information associated with more than one SRS resource set of the one or more SRS resource sets configured for the UE 104.

Upon receiving the partial spatial reference configuration signal 106, in some embodiments, the UE 104 is configured to process the partial spatial reference configuration signal 106 and determine the partial spatial reference resource configured for the one or more SRS resources associated with the select SRS resource set, based on processing the partial spatial reference configuration signal 106. In some embodiments, the UE 104 is further configured to generate one or more SRS transmit beam patterns for transmitting the one or more SRS resources, respectively associated with the select SRS resource set, that forms an SRS transmission 112, to the gNodeB 102, based on the determined partial spatial reference resource. In some embodiments, the one or more SRS transmit beam patterns (comprising the SRS transmission 112) are generated by the UE 104 in such a way that the one or more SRS transmit beam patterns are in a spatial neighborhood of a beam pattern associated with the determined partial spatial reference resource. In some embodiments, the one or more SRS transmit beam patterns are spatially correlated to the beam pattern of the configured partial spatial reference resource. In some embodiments, the one or more SRS transmit beam patterns associated with the SRS transmission 112 are different from the beam pattern associated with the configured partial spatial reference resource.

In some embodiments, the one or more SRS transmit beam patterns (comprising the SRS transmission 112) are generated by the UE 104 based on the determined partial spatial reference resource, in accordance with a predefined partial spatial reference resource mapping that defines a mapping between SRS transmit beam patterns and a beam pattern of a corresponding partial spatial reference resource. In some embodiments, at least one SRS transmit beam pattern of the one or more SRS transmit beam patterns associated with the SRS transmission 112 is different from the rest of the SRS beam patterns of the SRS transmission 112. Alternately, in some embodiments, each SRS transmit beam pattern of the one or more SRS transmit beam patterns associated with the SRS transmission 112 may be different from one another. In some embodiments, the one or more SRS transmit beam patterns associated with the SRS transmission 112 are generated by the UE 104 in a time-domain multiplexed manner.

In some embodiments, the partial spatial reference resource configured for the select SRS resource set comprises a downlink (DL) resource, for example, channel state information reference signal (CSI-RS), synchronization signal block (SSB) etc. In some embodiments, the partial spatial reference resource can comprise pass-loss reference resources used for SRS transmission power calculation. For example, a DL CSI-RS or SSB resource, which is used for pass-loss computation for transmitting the SRS resources within an SRS resource set, may be re-used as the partial spatial reference resource. In such embodiments, the one or more SRS transmit beam patterns, generated by the UE 104, for transmitting the one or more SRS resources are in the spatial neighborhood of a receive (Rx) beam pattern acquired by the UE 104 for receiving the DL resource (i.e., the CSI-RS, SSB etc.). In some embodiments, the CSI-RS, SSB etc. are quasi co-located with the current activated DL physical downlink control channel (PDCCH) or physical downlink shared channel (PDSCH). In such embodiments, the one or more SRS transmit beam patterns, generated by the UE 104 are in the spatial neighborhood of current activated RX beams for PDSCH/PDCCH reception by the UE 104.

In some embodiments, the partial spatial reference resource configured for the select SRS resource set comprises an uplink SRS resource in a different SRS resource set (i.e., an SRS resource set that is different from the select SRS resource set) associated with the UE 104. In such embodiments, the one or more SRS transmit beam patterns, generated by the UE 104, for transmitting the one or more SRS resources associated with the select SRS resource set are in the spatial neighborhood of a transmit (Tx) beam pattern used by the UE 104 for transmitting the uplink SRS resource. In some embodiments, utilizing the uplink SRS resource as the partial spatial reference resource results in hierarchical TX beam sweeping, further details of which are given in an embodiment below. Further, in some embodiments, the partial spatial reference resource associated with the select SRS resource set is configured as “None”, thereby indicating to the UE 104 to perform global transmit beam sweeping for the set of SRS resources associated with the select SRS resource set. In such embodiments, the UE 104 may be configured to utilize SRS TX beam patterns which cover the full spatial coverage for transmitting the set of SRS resources in the select SRS resource set.

In some embodiments, for an aperiodic SRS resource, the partial spatial reference resource comprises the scheduling physical downlink control channel (PDCCH) that schedules the transmission of the one or more SRS resources associated with the select SRS resource set. Further, in some embodiments, the partial spatial reference information (included within the partial spatial reference configuration signal 106) provided to the UE 104 comprises an index that identifies the partial spatial reference resource associated therewith from a list of partial spatial reference resources pre-configured for the UE 104. In some embodiments, the partial spatial reference information is provided from the gNodeB 102 to the UE 104, via radio resource configuration (RRC) signaling. In other words, in some embodiments, the partial spatial reference configuration signal 106 comprises RRC signaling. For some types of SRS, e.g. periodic SRS, semi-persistent SRS, medium access control (MAC) control element (CE) may be used to override the RRC configured partial spatial reference information provided to the UE 104. In such embodiments, the gNodeB 102 is configured to provide an updated partial spatial reference configuration signal (not shown in FIG. 1) comprising an updated partial spatial reference information for the one or more SRS resources, to the UE 104, using a MAC CE, in order to override the partial spatial reference information comprised within the partial spatial reference configuration signal 106 previously provided by the RRC signaling. In some embodiments, utilizing a MAC CE to update the partial spatial reference information is less complex compared to using RRC signaling.

In some embodiments, the UE 104 is configured to generate the SRS transmission 112 comprising the one or more SRS transmit beams for transmitting the one or more SRS resources associated with the select SRS resource set, in response to processing an SRS triggering signal 110, received from the gNodeB 102. Therefore, in some embodiments, the gNodeB 102 is further configured to generate an SRS triggering signal 110 for triggering the one or more SRS resources associated with the select SRS resource set associated with the UE 104. However, in other embodiments, the SRS triggering signal 110 may be configured to trigger SRS resources associated with one or more SRS resource sets associated with the UE 104. In some embodiments, the gNodeB 102 is further configured to provide the SRS triggering signal 110 to the UE 104.

In some embodiments, the gNodeB 102 is further configured to receive a UE capability signal 108 from the UE 104, prior to providing the SRS triggering signal 110 to the UE 104. In some embodiments, the UE capability signal 108 comprises information on a number of SRS resources associated with the one or more SRS resource sets of the UE 104 that can be concurrently transmitted by the UE 104. In such embodiments, the SRS triggering signal 110 is generated at the gNodeB 102 in a way that the number of simultaneously triggered SRS resources across all SRS resource sets associated with the UE 104 does not exceed the UE indicated number (indicated via the UE capability signal 108). In such embodiments, the UE 104 is further configured to generate the UE capability signal 108 and provide the UE capability signal 108 to the gNodeB 102, in order to enable the gNodeB 102 to determine the number of SRS resources associated with the one or more SRS resource sets of the UE 104 that can be concurrently transmitted by the UE 104. In some embodiments, triggering SRS resources associated with different SRS resource sets increases the TX beam candidates, which, in turn, improves the UE TX beam sweeping efficiency.

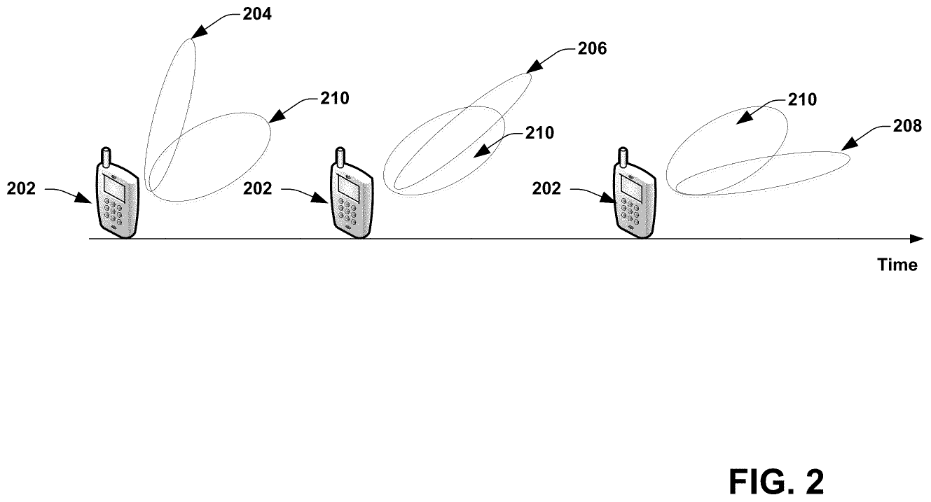

FIG. 2 illustrates exemplary SRS beam patterns generated by a UE 202 for transmitting one or more SRS resources associated with the UE 202, based on a partial reference resource, according to one embodiment of the disclosure. In particular, in this embodiment, the UE 202 is shown to be configured with an SRS resource set comprising 3 SRS resources, that is, SRS resource 1, SRS resource 2 and SRS resource 3. The SRS resource set is further configured with a partial reference resource (e.g., by a gNodeB associated therewith). In some embodiments, the partial reference resource may be a CSI-RS, an SSB or another SRS. The UE 202 is configured to generate SRS transmit beam pattern 204, SRS transmit beam pattern 206 and the SRS transmit beam 208 for transmitting the SRS resource 1, the SRS resource 2 and SRS resource 3, respectively. As can be seen in FIG. 2, the SRS transmit beam pattern 204, the SRS transmit beam pattern 206 and the SRS transmit beam pattern 208 are in the spatial neighborhood of a beam pattern 210 acquired by the UE 202 for the configured partial reference resource. In some embodiments, the SRS transmit beam pattern 204, the SRS transmit beam pattern 206 and the SRS transmit beam pattern 208 are generated by the UE 202 in a time-domain multiplexed manner.

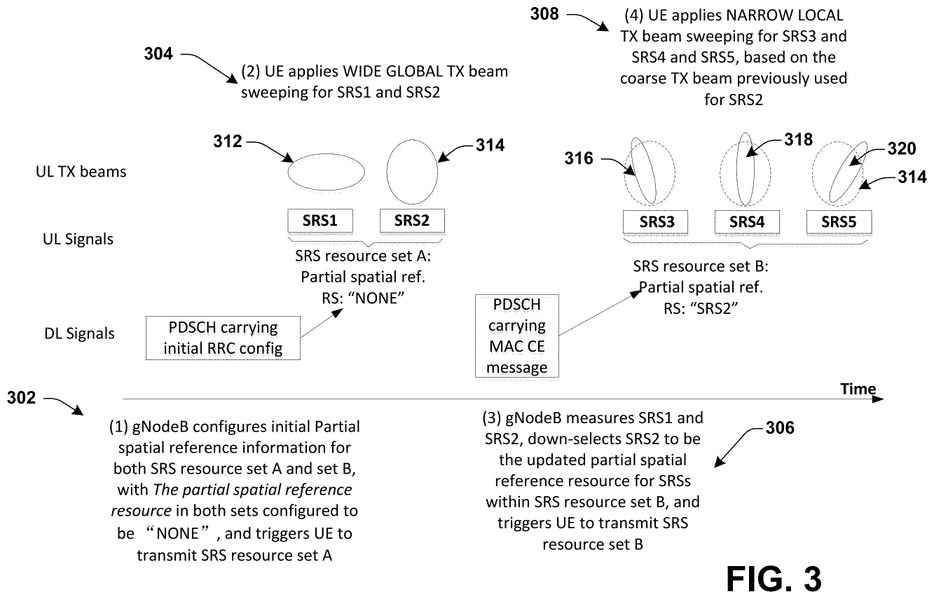

FIG. 3 illustrates a use case for hierarchical user equipment (UE) Tx beam sweeping, according to one embodiment of the disclosure. In this embodiment, a UE (e.g., the UE 104 in FIG. 1) configured with 2 SRS resource sets, that is, SRS resource set A and SRS resource set B is disclosed. At 302, a gNodeB (e.g., the gNodeB 102 in FIG. 1) configures an initial partial spatial reference information for both the SRS resource set A and the SRS resource set B, where the partial spatial reference resource (e.g., SRS-partialSpatialRelationInfo) for both the SRS resource set A and the SRS resource set B is configured to be “NONE”. In some embodiments, the initial partial spatial reference information is provided to the UE from the gNodeB by RRC signaling. Then, the gNodeB triggers the UE to transmit SRS resource set A. At 304, the UE applies wide global beam sweeping for SRS resource 1 and SRS resource 2 associated with the SRS resource set A, based on the SRS transmit beam patterns 312 and 314 respectively. At 306, the gNodeB measures SRS resource 1 and SRS resource 2, down-selects SRS resource 2 to be the updated partial spatial reference resource for the SRS resource 3, the SRS resource 4 and the SRS resource 5 within SRS resource set B, and triggers UE to transmit SRS resource set B. In some embodiments, the updated partial spatial reference resource is provided from the gNodeB to the UE via MAC control element (CE). At 308, UE applies NARROW LOCAL TX beam sweeping for the SRS resource 3, the SRS resource 4 and the SRS resource 5, based on the SRS transmit beam 314 previously used for the SRS resource 2. In particular the UE generates the SRS transmit beam pattern 316, the SRS transmit beam pattern 318 and the SRS transmit beam pattern 320 for transmitting the SRS resource 3, the SRS resource 4 and the SRS resource 5, respectively. As can be seen in FIG. 3, the SRS transmit beam pattern 316, the SRS transmit beam pattern 318 and the SRS transmit beam pattern 320 are in the spatial neighborhood of the SRS transmit beam 314 previously used for the SRS resource 2.

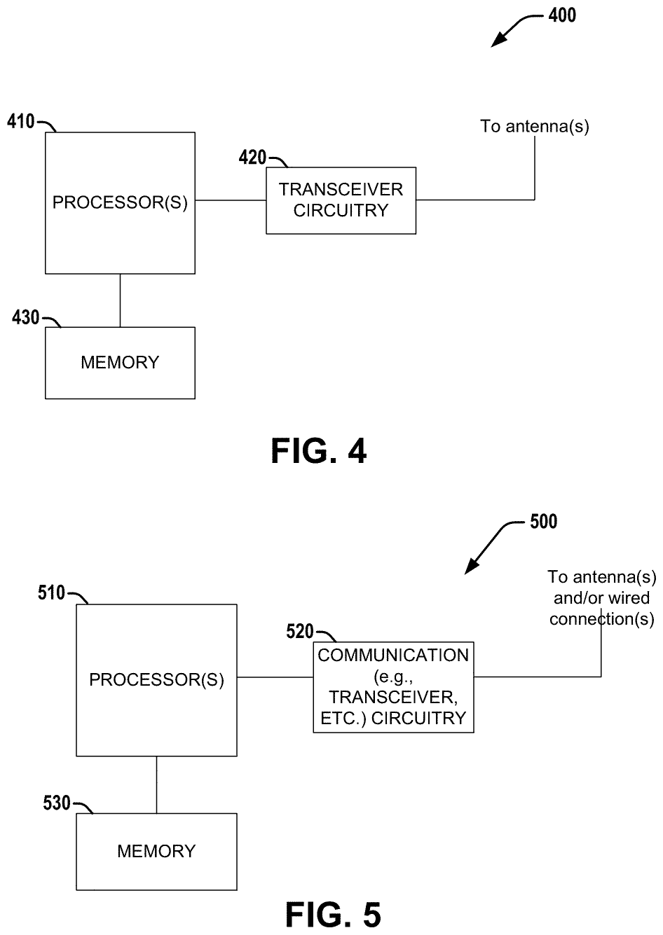

Referring to FIG. 4, illustrated is a block diagram of an apparatus 400 employable at a Base Station (BS), eNodeB, gNodeB or other network device that facilitates to perform gNodeB supervised sounding reference signal (SRS) transmit (Tx) beam sweeping at the user equipment (UE) side, according to various aspects described herein. The apparatus 400 can include one or more processors 410 comprising processing circuitry and associated interface(s) (e.g., a radio frequency interface), communication circuitry 420, which can comprise one or more of transmitter circuitry (e.g., associated with one or more transmit chains) or receiver circuitry (e.g., associated with one or more receive chains), wherein the transmitter circuitry and receiver circuitry can employ common circuit elements, distinct circuit elements, or a combination thereof), and memory 430 (which can comprise any of a variety of storage mediums and can store instructions and/or data associated with one or more of processor(s) 410 or communication circuitry 420). In various aspects, the apparatus 400 can be included within an Evolved Universal Terrestrial Radio Access Network (E-UTRAN) Node B (Evolved Node B, eNodeB, or eNB), next generation Node B (gNodeB or gNB) or other base station or TRP (Transmit/Receive Point) in a wireless communications network. In some aspects, the processor(s) 410, communication circuitry 420, and the memory 430 can be included in a single device, while in other aspects, they can be included in different devices, such as part of a distributed architecture. In some embodiments, the apparatus 400 could be included within the gNodeB 102 of FIG. 1.

Referring to FIG. 5, illustrated is a block diagram of an apparatus 500 employable at a user equipment (UE) or other network device (e.g., IoT device) that facilitates to perform gNodeB supervised sounding reference signal (SRS) transmit (Tx) beam sweeping at the user equipment (UE) side, according to various aspects described herein. Apparatus 500 can include one or more processors 510 comprising processing circuitry and associated interface(s) (e.g., radio frequency interface), transceiver circuitry 520 (e.g., comprising RF circuitry, which can comprise transmitter circuitry (e.g., associated with one or more transmit chains) and/or receiver circuitry (e.g., associated with one or more receive chains) that can employ common circuit elements, distinct circuit elements, or a combination thereof), and a memory 530 (which can comprise any of a variety of storage mediums and can store instructions and/or data associated with one or more of processor(s) 510 or transceiver circuitry 520). In various aspects, apparatus 500 can be included within a user equipment (UE).

In various aspects discussed herein, signals and/or messages can be generated and output for transmission, and/or transmitted messages can be received and processed. Depending on the type of signal or message generated, outputting for transmission (e.g., by processor(s) 510) can comprise one or more of the following: generating a set of associated bits that indicate the content of the signal or message, coding (e.g., which can include adding a cyclic redundancy check (CRC) and/or coding via one or more of turbo code, low density parity-check (LDPC) code, tailbiting convolution code (TBCC), etc.), scrambling (e.g., based on a scrambling seed), modulating (e.g., via one of binary phase shift keying (BPSK), quadrature phase shift keying (QPSK), or some form of quadrature amplitude modulation (QAM), etc.), and/or resource mapping (e.g., to a scheduled set of resources, to a set of time and frequency resources granted for uplink transmission, etc.). Depending on the type of received signal or message, processing (e.g., by processor(s) 510) can comprise one or more of: identifying physical resources associated with the signal/message, detecting the signal/message, resource element group deinterleaving, demodulation, descrambling, and/or decoding. In some embodiments, the apparatus 500 could be included within the UE 104 of FIG. 1.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Example 1 is an apparatus configured to be employed in a gNodeB associated with a new radio (NR) communication system, comprising one or more processors configured to configure partial spatial reference information associated with at least one sounding reference signal (SRS) resource set of one or more SRS resource sets associated with a user equipment (UE), that forms a select SRS resource set comprising a set of SRS resources, wherein the partial spatial reference information associated with the select SRS resource set comprises information on a partial spatial reference resource configured for one or more SRS resources of the set of SRS resources associated with the select SRS resource set, to be utilized by the UE to generate one or more SRS transmit beam patterns for transmitting the one or more SRS resources, respectively associated with the select SRS resource set, such that the one or more SRS transmit beam patterns are in a spatial neighborhood of a beam pattern associated with the configured partial spatial reference resource; and generate a partial spatial reference configuration signal comprising the configured partial spatial reference information associated with the at least one SRS resource set comprising the select SRS resource set; and a radio frequency (RF) interface, configured to provide, to a radio frequency (RF) circuitry, the partial spatial reference configuration signal, for subsequent transmission to the UE.

Example 2 is an apparatus, including the subject matter of example 1, wherein the partial spatial reference resource is configured for all SRS resources of the set of SRS resources associated with the select SRS resource set.

Example 3 is an apparatus, including the subject matter of examples 1-2, including or omitting elements, wherein the partial spatial reference resource is configured for a select SRS resource associated with the select SRS resource set.

Example 4 is an apparatus, including the subject matter of examples 1-3, including or omitting elements, wherein the partial spatial reference resource comprises a plurality of partial spatial reference resources configured respectively for a plurality of SRS resources of the set of SRS resources, associated with the select SRS resource set.

Example 5 is an apparatus, including the subject matter of examples 1-4, including or omitting elements, wherein the partial spatial reference resource comprises a downlink resource.

Example 6 is an apparatus, including the subject matter of examples 1-5, including or omitting elements, wherein the partial spatial reference resource comprises an uplink SRS resource associated with an SRS resource set that is different from the select SRS resource set.

Example 7 is an apparatus, including the subject matter of examples 1-6, including or omitting elements, wherein the partial spatial reference resource comprises a path-loss reference resource.

Example 8 is an apparatus, including the subject matter of examples 1-7, including or omitting elements, wherein the partial spatial reference resource is configured as “None”, in order to indicate to the UE to perform global transmit beam sweeping for the set of SRS resources associated with the select SRS resource set.

Example 9 is an apparatus, including the subject matter of examples 1-8, including or omitting elements, wherein, for an aperiodic SRS resource, the partial spatial reference resource comprises the scheduling physical downlink control channel (PDCCH) that schedules the transmission of the one or more SRS resources.

Example 10 is an apparatus, including the subject matter of examples 1-9, including or omitting elements, wherein the partial spatial reference information provided to the UE comprises an index that identifies the partial spatial reference resource associated therewith from a list of partial spatial reference resources pre-configured for the UE.

Example 11 is an apparatus, including the subject matter of examples 1-10, including or omitting elements, wherein the partial spatial reference configuration signal comprises radio resource control (RRC) signaling.

Example 12 is an apparatus, including the subject matter of examples 1-11, including or omitting elements, wherein the one or more processors is further configured to provide an updated partial spatial reference configuration signal comprising an updated partial spatial reference information for the one or more SRS resources, to the UE, using an medium access control (MAC) control element (CE), in order to override the partial spatial reference information comprised within the partial spatial reference configuration signal provided by the RRC signaling.

Example 13 is an apparatus, including the subject matter of examples 1-12, including or omitting elements, wherein the one or more processors is further configured to generate an SRS triggering signal for triggering the one or more SRS resources associated with the select SRS resource set associated with the UE.

Example 14 is an apparatus, including the subject matter of examples 1-13, including or omitting elements, wherein, prior to generating the SRS triggering signal, the one or more processors is configured to process a UE capability signal received from the UE, wherein the UE capability signal comprises information on a number of SRS resources associated with the one or more SRS resource sets of the UE that can be concurrently transmitted by the UE.

Example 15 is an apparatus configured to be employed in a user equipment (UE) associated with a new radio (NR) system, comprising one or more processors configured to process a partial spatial reference configuration signal, received from a gNodeB associated therewith, wherein the partial spatial reference configuration signal comprises partial spatial reference information configured for at least one sounding reference signal (SRS) resource set of one or more SRS resource sets associated with the UE, that forms a select SRS resource set comprising a set of SRS resources, wherein the partial spatial reference information configured for the select SRS resource set comprises information on a partial spatial reference resource configured for one or more SRS resources of the set of SRS resources associated with the select SRS resource set, to be utilized by the UE to generate one or more SRS transmit beam patterns for transmitting the one or more SRS resources, respectively associated with the select SRS resource set; determine the partial spatial reference resource configured for the one or more SRS resources associated with the select SRS resource set, based on processing the partial spatial reference configuration signal; and generate the one or more SRS transmit beam patterns for transmitting the one or more SRS resources, respectively associated with the select SRS resource set, to the gNodeB, based on the determined partial spatial reference resource, such that the one or more SRS transmit beam patterns are in a spatial neighborhood of a beam pattern associated with the determined partial spatial reference resource.

Example 16 is an apparatus, including the subject matter of example 15, wherein the one or more processors is configured to generate the one or more SRS transmit beam patterns for transmitting the one or more SRS resources, based on processing an SRS triggering signal received from the gNodeB.

Example 17 is an apparatus, including the subject matter of examples 15-16, including or omitting elements, wherein the partial reference resource comprises a downlink (DL) resource or an uplink SRS resource that is different from the one or more SRS resources associated with the select SRS resource set.

Example 18 is an apparatus, including the subject matter of examples 15-17, including or omitting elements, wherein, when the determined partial spatial resource comprises the DL resource, the one or more SRS transmit beam patterns, generated by the UE, for transmitting the one or more SRS resources are in the spatial neighborhood of a receive (Rx) beam pattern acquired by the UE for receiving the configured partial spatial resource.

Example 19 is an apparatus, including the subject matter of examples 15-18, including or omitting elements, wherein, when the determined partial spatial resource comprises an uplink SRS resource, the one or more SRS transmit beam patterns, generated by the UE, for transmitting the one or more SRS resources are in the spatial neighborhood of a transmit (Tx) beam pattern used by the UE for transmitting the configured partial spatial resource.

Example 20 is an apparatus, including the subject matter of examples 15-19, including or omitting elements, wherein, when the determined partial spatial resource is configured as “None”, the one or more processors is configured to perform global transmit beam sweeping for the set of SRS resources associated with the select SRS resource set.

Example 21 is an apparatus, including the subject matter of examples 15-20, including or omitting elements, wherein the one or more processors is further configured to generate a UE capability signal comprising information on a number of SRS resources associated with the one or more SRS resource sets associated with the UE that can be concurrently transmitted by the UE; and provide the UE capability signal to the gNodeB associated therewith, via a radio frequency (RF) circuitry, in order to enable the gNodeB to determine the number of SRS resources associated with the one or more SRS resource sets that can be concurrently transmitted by the UE.

Example 22 is an apparatus, including the subject matter of examples 15-21, including or omitting elements, wherein the partial spatial reference configuration signal comprises radio resource control (RRC) signaling.

Example 23 is a computer readable storage device storing executable instructions that, in response to execution, cause one or more processors of a gNodeB to perform operations, the operations comprising configuring partial spatial reference information associated with at least one sounding reference signal (SRS) resource set of one or more SRS resource sets associated with a user equipment (UE), that forms a select SRS resource set comprising a set of SRS resources, wherein the partial spatial reference information associated with the select SRS resource set comprises information on a partial spatial reference resource configured for one or more SRS resources of the set of SRS resources associated with the select SRS resource set, to be utilized by the UE to generate one or more SRS transmit beam patterns for transmitting the one or more SRS resources, respectively associated with the select SRS resource set, such that the one or more SRS transmit beam patterns are in a spatial neighborhood of a beam pattern associated with the configured partial spatial reference resource; and generating a partial spatial reference configuration signal comprising the configured partial spatial reference information associated with the at least one SRS resource set comprising the select SRS resource set; and providing the partial spatial reference configuration signal, to a radio frequency (RF) circuitry, for subsequent transmission to the UE.

Example 24 is a computer readable storage device, including the subject matter of example 23, wherein the partial reference resource comprises a downlink (DL) resource or an uplink SRS resource that is different from the one or more SRS resources associated with the select SRS resource set.

Example 25 is a computer readable storage device, including the subject matter of examples 23-24, including or omitting elements, wherein the partial spatial reference configuration signal comprises radio resource control (RRC) signaling.

While the invention has been illustrated, and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

1. An apparatus configured to be employed in a base station (BS) associated with a new radio (NR) communication system, comprising:
one or more processors configured to:
configure partial spatial reference information associated with at least one sounding reference signal (SRS) resource set of one or more SRS resource sets associated with a user equipment (UE), that forms a select SRS resource set comprising a set of SRS resources, wherein the partial spatial reference information associated with the select SRS resource set comprises information on a partial spatial reference resource configured for one or more SRS resources of the set of SRS resources associated with the select SRS resource set, to be utilized by the UE to generate one or more SRS transmit beam patterns for transmitting the one or more SRS resources, respectively associated with the select SRS resource set, such that the one or more SRS transmit beam patterns are in a spatial neighborhood of a beam pattern associated with the configured partial spatial reference resource; and
generate a partial spatial reference configuration signal comprising the configured partial spatial reference information associated with the at least one SRS resource set comprising the select SRS resource set; and
a radio frequency (RF) interface, configured to provide, to a radio frequency (RF) circuitry, the partial spatial reference configuration signal, for subsequent transmission to the UE.

2. The apparatus of claim 1, wherein the partial spatial reference resource is configured for all SRS resources of the set of SRS resources associated with the select SRS resource set.

3. The apparatus of claim 1, wherein the partial spatial reference resource is configured for a select SRS resource associated with the select SRS resource set.

4. The apparatus of claim 3, wherein the partial spatial reference resource comprises a plurality of partial spatial reference resources configured respectively for a plurality of SRS resources of the set of SRS resources, associated with the select SRS resource set.

5. (canceled)

6. The apparatus of claim 1, wherein the partial spatial reference resource comprises an uplink SRS resource associated with an SRS resource set that is different from the select SRS resource set.

7. (canceled)

8. The apparatus of claim 1, wherein the partial spatial reference resource is configured as “None”, in order to indicate to the UE to perform global transmit beam sweeping for the set of SRS resources associated with the select SRS resource set.

9. The apparatus of claim 1, wherein, for an aperiodic SRS resource, the partial spatial reference resource comprises a scheduling physical downlink control channel (PDCCH) that schedules a transmission of the one or more SRS resources.

10. The apparatus of claim 1, wherein the partial spatial reference information provided to the UE comprises an index that identifies the partial spatial reference resource associated therewith from a list of partial spatial reference resources pre-configured for the UE.

11. (canceled)

12. (canceled)

13. The apparatus of claim 1, wherein the one or more processors is further configured to generate an SRS triggering signal for triggering the one or more SRS resources associated with the select SRS resource set associated with the UE.

14. The apparatus of claim 13, wherein, prior to generating the SRS triggering signal, the one or more processors is configured to process a UE capability signal received from the UE, wherein the UE capability signal comprises information on a number of SRS resources associated with the one or more SRS resource sets of the UE that can be concurrently transmitted by the UE.

15. An apparatus configured to be employed in a user equipment (UE) associated with a new radio (NR) system, comprising:
one or more processors configured to:
process a partial spatial reference configuration signal, received from a base station (BS) associated therewith, wherein the partial spatial reference configuration signal comprises partial spatial reference information configured for at least one sounding reference signal (SRS) resource set of one or more SRS resource sets associated with the UE, that forms a select SRS resource set comprising a set of SRS resources, wherein the partial spatial reference information configured for the select SRS resource set comprises information on a partial spatial reference resource configured for one or more SRS resources of the set of SRS resources associated with the select SRS resource set, to be utilized by the UE to generate one or more SRS transmit beam patterns for transmitting the one or more SRS resources, respectively associated with the select SRS resource set;
determine the partial spatial reference resource configured for the one or more SRS resources associated with the select SRS resource set, based on processing the partial spatial reference configuration signal; and
generate the one or more SRS transmit beam patterns for transmitting the one or more SRS resources, respectively associated with the select SRS resource set, to the (BS), based on the determined partial spatial reference resource, such that the one or more SRS transmit beam patterns are in a spatial neighborhood of a beam pattern associated with the determined partial spatial reference resource.

16. The apparatus of claim 15, wherein the one or more processors is configured to generate the one or more SRS transmit beam patterns for transmitting the one or more SRS resources, based on processing an SRS triggering signal received from the BS.

17. The apparatus of claim 15, wherein the partial spatial reference resource comprises a downlink (DL) resource or an uplink SRS resource that is different from the one or more SRS resources associated with the select SRS resource set.

18. (canceled)

19. The apparatus of claim 17, wherein, when the determined partial spatial resource comprises an uplink SRS resource, the one or more SRS transmit beam patterns, generated by the UE, for transmitting the one or more SRS resources are in the spatial neighborhood of a transmit (Tx) beam pattern used by the UE for transmitting the configured partial spatial resource.

20. The apparatus of claim 15, wherein, when the determined partial spatial resource is configured as “None”, the one or more processors is configured to perform global transmit beam sweeping for the set of SRS resources associated with the select SRS resource set.

21. The apparatus of claim 15, wherein the one or more processors is further configured to:
generate a UE capability signal comprising information on a number of SRS resources associated with the one or more SRS resource sets associated with the UE that can be concurrently transmitted by the UE; and
provide the UE capability signal to the BS associated therewith, via a radio frequency (RF) circuitry, in order to enable the BS to determine the number of SRS resources associated with the one or more SRS resource sets that can be concurrently transmitted by the UE.

22. The apparatus of claim 15, wherein the partial spatial reference configuration signal comprises radio resource control (RRC) signaling.

23. A computer readable storage device storing executable instructions that, in response to execution, cause one or more processors of a BS to perform operations, the operations comprising:
configuring partial spatial reference information associated with at least one sounding reference signal (SRS) resource set of one or more SRS resource sets associated with a user equipment (UE), that forms a select SRS resource set comprising a set of SRS resources, wherein the partial spatial reference information associated with the select SRS resource set comprises information on a partial spatial reference resource configured for one or more SRS resources of the set of SRS resources associated with the select SRS resource set, to be utilized by the UE to generate one or more SRS transmit beam patterns for transmitting the one or more SRS resources, respectively associated with the select SRS resource set, such that the one or more SRS transmit beam patterns are in a spatial neighborhood of a beam pattern associated with the configured partial spatial reference resource; and
generating a partial spatial reference configuration signal comprising the configured partial spatial reference information associated with the at least one SRS resource set comprising the select SRS resource set; and
providing the partial spatial reference configuration signal, to a radio frequency (RF) circuitry, for subsequent transmission to the UE.

24. The computer readable storage device of claim 23, wherein the partial spatial reference resource comprises a downlink (DL) resource or an uplink SRS resource that is different from the one or more SRS resources associated with the select SRS resource set.

25. The computer readable storage device of claim 23, wherein the partial spatial reference configuration signal comprises radio resource control (RRC) signaling.
